(19) United States
(12) Patent Application Publication
(10) Pub. No.: US 2009/0080558 A1
(43) Pub. Date: Mar. 26, 2009

(54) SPACE-TIME MIMO WIRELESS SYSTEM BASED ON FEEDBACK OPTIMUM WEIGHT DESIGN

(76) Inventor: John F. AN, Keelung (TW)

Correspondence Address: BIRCH STEWART KOLASCH & BIRCH, PO BOX 747, FALLS CHURCH, VA, 22040-0747, US

(21) Appl. No.: 11/861,099

(22) Filed: Sep. 25, 2007

(51) Int. Cl. H04L 1/02

(52) U.S. Cl. 375/267

(57) ABSTRACT

A FOW-based 2-by-2 space-time MIMO wireless system based on Alamouti's Space-Time block code with a feedback optimum weight (FOW) technique is provided, including a MIMO transmitter, a 2-by-2 MIMO channel, two FOW-based MIMO receivers, an optimum weight vector module, a Bayes decision algorithm module, a coherent combining unit, and a maximum likelihood detector (MLD). The FOW-based 2-by-2 space-time MIMO wireless system of the present invention uses the Bayes decision algorithm to determine the optimum weights at the receiver which multiplies the transmitted output signals at spatial antennas via up-link Fast Channel Feedback (i.e. closed-loop MIMO) and also the corresponding receiving signals. In addition, the present invention includes a Scheduler design to arrange these weight elements in accordance with space-time constellation signals, which allows linear processing using Alamouti's 2-branch maximum likelihood detection without increasing the hardware complexity.

### BACKGROUND OF THE INVENTION

1. Field of the Invention

The present invention generally relates to a space-time MIMO broadband wireless technology, and in particular to a feedback optimum weight (FOW) design for multiple-input multiple-out put (MIMO) wireless systems.

2. The Prior Arts

Implementation of high-data-rate wireless local area networks (WLAN; IEEE802.11n) and wireless metropolitan area networks (WiMAX; IEEE802.16d/e) have been focused on the MIMO wireless system in combination with space-time block code (STBC) scheme and orthogonal frequency-division multiplexing (OFDM) technology (i.e. MIMO-OFDM). MIMO wireless system takes advantage of the spatial diversity gain by spatially separated antennas on both receiver and transmitter sides, which effectively mitigates the fading effects and increases the channel capacity in rich Rayleigh multipath environments. To obtain the best MIMO performance, one must either increase the number of antennas on both Tx/Rx sides or adopt the optimum antenna spacing design (i.e. correlation issue). As such, 2-by-2 MIMO implementation is considered in the Wave 2 WiMAX Forum certification feature for WiMAX devices.

In theory, MIMO signals propagate over an independently and identically distributed (i.i.d.) multipath fading channel that results in a linearly increasing channel capacity with the minimum number of transmit and receive antennas. Thus, the equi-powered transmitted signal vector over an independently and identically distributed (i.i.d.) multipath fading channel is usually accepted under spatially white with zero mean and unit variance. This ideally gives the power covariance matrix a diagonal positive defined weight matrix (i.e. trace of square matrix) without considering the power imbalance across the channel coefficients on the spatial sub-channels. However, in actual application, the inter-subchannel correlations and the channel gain imbalances due to inadequate scattering and/or inadequate antenna spacing cause the signal dependent interference, resulting in the spectral efficiency degradation.

To improve receiver performance, conventional MIMO wireless system try to improve the received mean signal-to-noise power ratio (SNR) with channel covariance matrix under total transmitted power constraint with the need of channel knowledge and using transmitter feedback signalling channel, as is taught in J. Kermoal, et al. “A stochastic MIMO radio channel model with experimental validation,” IEEE JSAC, Vol. 20, pp. 1211-1226, August 2002 (Hereinafter referred to as “Kermoal Reference”). Furthermore, conventional MIMO wireless system does not use a feedback optimum weight (FOW) scheme for enhancing the receiver performance. Because of issues such as imbalanced channel power occurrence as caused by the antenna spatial correlations at the transmitter and receivers over multipath fading channel, the overall quality-of-service for high-speed data transmission have been negatively affected. Indeed, the conventional MIMO wireless system suffers from inter-subchannel correlations and channel gain imbalances due to inadequate scattering and/or inadequate antenna spacing causing signal dependent interference over time-varying fading channel, which is critical to system capacity and spectral efficiency. Compared to an independent fading MIMO channel, the capacity of a spatially correlated fading channel is substantially reduced.

### SUMMARY OF THE INVENTION

The present invention has been made to overcome the aforementioned limitations pertaining to receiver performance and overall quality-of-service for high-speed data transmission over the MIMO wireless system. The primary objective of the present invention is to provide a FOW-based space-time MIMO wireless system having enhanced received signal-to-noise power ratio (SNR) to improve the system capacity. The present invention is applicable to frequency, time, and space diversity wireless systems, such as for orthogonal frequency division multiplexing (OFDM), spatial multiplexing (SM), single-carrier based code-division multiple access (SC-CDMA), and orthogonal space-time block code (STBC).

Another objective of the present invention is to provide a FOW-based space-time MIMO wireless system with increased spectral efficiency, and data throughput, applicable to mobile terminal and base-station transceivers under the MIMO wireless technology.

Yet another objective of the present invention is to provide a device and scheme for WiMAX system using MIMO space-time block coding and spatial multiplexing, as well as transmitter adaptive antenna (i.e. Beamforming) with increasing system coverage and capacity.

To achieve the above objectives, the present invention provides a FOW-based space-time MIMO wireless system based on Alamouti's Space-Time block code (S. M. Alamouti, “A simple Transmit Diversity Technique for Wireless Communications,” IEEE JSAC, vol. 16, October 1998, pp. 1451-1458) with a feedback optimum weight (FOW) technique. The optimum weight vector maximizes the most likely “closest” transmitted signal power to the received vector with minimum “Risk” criterion based on the first and second-order statistics of the estimated MIMO sub-channels. The FOW-based 2-by-2 space-time MIMO wireless system of the present invention uses the Bayes decision algorithm to determine the optimum weights at the receiver which multiplies both the transmitted output signals at spatial antennas via up-link Fast Channel Feedback (i.e. closed-loop MIMO) and the corresponding received signals. In addition, the present invention includes a Scheduler design to arrange these weight elements in accordance with space-time constellation signals, which allows linear processing using Alamouti's 2-branch maximum likelihood detection without increasing the hardware complexity. The performance of the provided technique is verified by bit-error-rate (BER) analyses using frequency-flat fading channel simulation, in the presence of spatial correlation across antennas and maximum Doppler frequency.

The present invention also provides a method of spatially coherent combining with respect to each transmitted signal over MIMO channel, which has full-rank of the optimum channel covariance; obtaining the larger eigenvalues than the original one (which is without optimum weight); resulting in an improvement in the average SNR performance and channel capacity. The optimum channel covariance required for the optimum decision algorithms is updated adaptively per signal block length without the needs of the channel state information at the transmitter side. The block length could be adaptively adjusted in according to the propagation environment. However, small length L suffers less Doppler frequency, but increases the system iterative computational load in the receiver side.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention will be apparent to those skilled in the art by reading the following detailed description of an embodiment thereof, with reference to the attached drawings, in which:

FIG. 1 shows a schematic view of a block diagram of an FOW-based 2-by-2 ST-MIMO wireless system according to an embodiment of the present invention;

FIG. 2 shows a flowchart depicting an algorithm for implementing the optimum sub-channel weight scheme according to the embodiment of the present invention; and

FIGS. 3a and 3b show a schematic view of the Bit-Error-Rate (BER) and Symbol-Error-Rate (SER) results for a plurality of spatial correlation channels at the transmit and receive sides according to a first set of conditions in accordance to the embodiment of the present invention.

### DETAILED DESCRIPTION OF THE EMBODIMENT

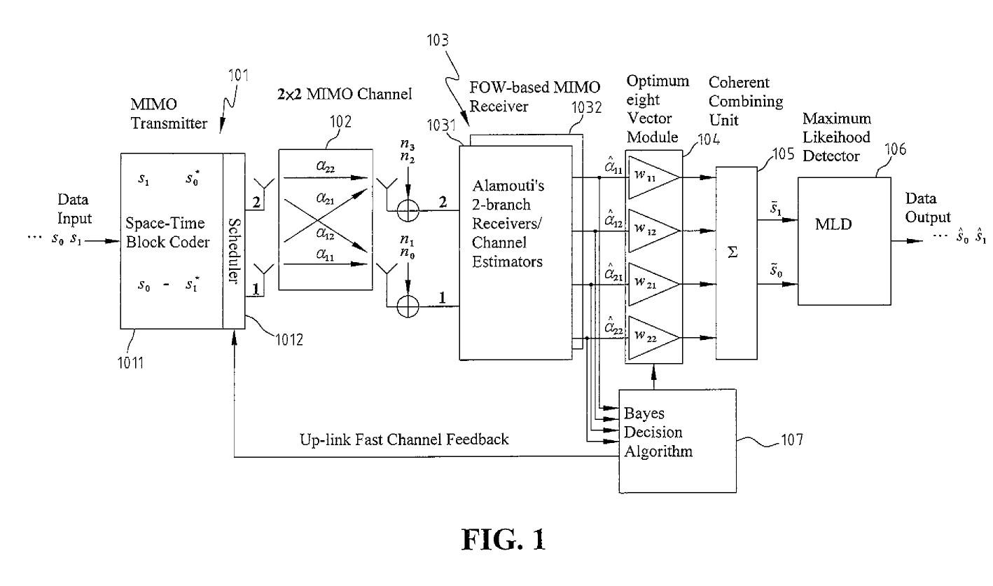

FIG. 1 shows a schematic view of a block diagram of an FOW-based 2-by-2 ST-MIMO wireless system of the present invention. As shown in FIG. 1, a MIMO wireless system in the form of a 2-by-2 Space-time MIMO (2×2 ST-MIMO) wireless system includes a MIMO transmitter 101, a 2-by-2 MIMO channel 102, two FOW-based MIMO receiver 1031, 1032, an optimum weight vector 104, a coherent combining unit 105, a maximum likelihood detector (MLD) 106, and a Bayes decision algorithm module 107. MIMO transmitter 101 further includes a space-time block coder 1011 and a scheduler 1012. The main feature of the present invention is the addition of scheduler 1012, optimum weight vector module 104, and Bayes decision algorithm module 107. Scheduler 1012 is added to MIMO transmitter 101 for receiving schedule table from Bayes decision algorithm module 107 through an uplink fast channel feedback. Optimum weight factor module 104 is placed between FOW-based MIMO receivers 1031, 1032 and coherent combining unit 105. Optimum weight vector module 104 is for receiving complex channel coefficients and computing optimum weight vector with information forwarded from Bayes decision algorithm module 107. The weighted signals are then fed to coherent combining unit 105 for summation. Bayes decision algorithm module 107 receives the same complex channel coefficients from FOW-based MIMO receivers 1031, 1032 to determine the weight elements. After deciding the weight elements, Bayes decision algorithm module 107 forwards the result to optimum weight vector module 104 and also feeds back to scheduler 1012 through an uplink fast channel feedback. Scheduler 1012 is designed to arrange the weight elements in accordance with space-time constellation signals so that the result allows linear processing by using Alamouti 2-branch maximum likelihood detection without increasing hardware complexity. As shown in FIG. 1, the MIMO wireless system of the present invention has 2-element transmitting antennas and 2-element receiving antennas. Multiplexing operation of a plurality of data streams from single user onto a down-link sub-channel in a multipath channel is generated using Alamouti space-time encoding scheme, in which the complex channel coefficients (α₁₁,α₁₂,α₂₁,α₂₂) are detected by the channel estimators at the receiver, and then forwarded to the Bayes decision for generating an optimum weight vector W=[w₁₁w₁₂w₂₁w₂₂].

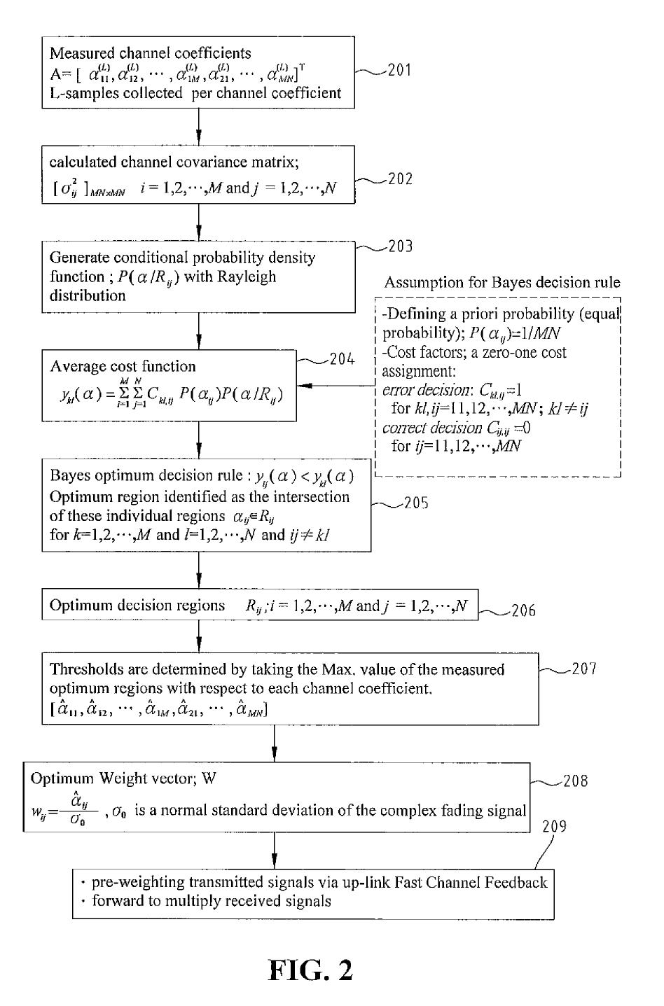

The following describes the Bayes decision algorithm used in determining the weight element in the present invention. The following description refers to FIG. 2, which shows a flowchart depicting an algorithm for implementing the optimum sub-channel weight scheme.

### A. Extended Bayes Decision Algorithm for an M-by-N MIMO System

FIG. 2 shows a flow chart of the Bayes decision algorithm that determines the optimum weight vector (W) at the receiver which multiplies the transmitted output signals at spatial antennas via uplink Fast Channel Feedback and the corresponding received signals, according to the embodiment of the present invention, especially taking into consideration of the signal propagations over the spatially correlated antennas on both the transmit and receive sides. Step 201 is to measure the channel coefficients. Step 202 is to calculate the channel covariance matrix. Step 203 is to generate conditional probability density function with Rayleigh distribution. Step 204 is to calculate the average cost function using the assumption of Bayes decision rules, shown as the box on the right to step 204. A generic Bayes decision rule for an M-by-N FOW-MIMO system that employs the average cost criterion over M-likelihood receiving antennas is described in this section. The average cost for a decision is therefore selecting the optimal received signal range such that the average cost is minimized using a number of assumptions as follows (shown as the dash-lined box in FIG. 2):

1) A priori probabilities and conditional probability density functions: The statistical properties related to the MN-hypotheses can be categorized into the conditional probability density function, P(α/Rᵢⱼ), and its corresponding a priori probability, P(αᵢⱼ), for each channel coefficient αᵢⱼ. The conditional probability density function of the envelope of αᵢⱼ, thereafter represented by P(α/Rᵢⱼ) shows a Rayleigh distribution, and it's a priori probability P(αᵢⱼ) given to each channel coefficient is assumed to be equal (i.e. P(α₁₁)=P(α₂₁)= . . . =P(α_{MN})=q; q=1/MN).
2) Cost factors: According to Bayes costs, a zero-one cost assignment is considered here that all costs for errors being 1 and all costs for correct decision being zero, as follows:

error decision: C_{kl,ij}=1 for kl,ij=11, 12, . . . , MN; kl≠ij

correct decision: C_{lj,lj=}0 for ij=11, 12, . . . , MN

The average cost for a decision is defined as follows:

$$\begin{matrix}\overline{C} = {\sum }_{i = 1}^{M} {\sum }_{j = 1}^{N} {\sum }_{k = 1}^{M} {\sum }_{l = 1}^{N} {C}_{kl , ij} P ( {α}_{ij} ) \int \int … {\int }_{{R}_{kl}} P ( α / {R}_{ij} ) d s \\ = \int \int … {\int }_{{R}_{11}} {\sum }_{i = 1}^{M} {\sum }_{j = 1}^{N} {C}_{11 , ij} P ( {α}_{ij} ) P ( α / {R}_{ij} ) + \\ \int \int … {\int }_{{R}_{12}} {\sum }_{i = 1}^{M} {\sum }_{j = 1}^{N} {C}_{12 , ij} P ( {α}_{ij} ) P ( α / {R}_{ij} ) + … + \\ \int \int … {\int }_{{R}_{21}} {\sum }_{i = 1}^{M} {\sum }_{j = 1}^{N} {C}_{21 , ij} P ( {α}_{ij} ) P ( α / {R}_{ij} ) + \\ \int \int … {\int }_{{R}_{22}} {\sum }_{i = 1}^{M} {\sum }_{j = 1}^{N} {C}_{22 , ij} P ( {α}_{ij} ) P ( α / {R}_{ij} ) + … + \\ \int \int … {\int }_{{R}_{MN}} {\sum }_{i = 1}^{M} {\sum }_{j = 1}^{N} {C}_{MN , ij} P ( {α}_{ij} ) P ( α / {R}_{ij} )\end{matrix}$$

The assignment of each α to a decision signal range, Rᵢⱼ, is to be made such that the cost is minimized. Invoking the definition of the average cost function introduced in (1), the integrands can be rewritten as 209. Thus, the optimum weights are obtained and feed-backed to the scheduler at the transmitter, as shown in FIG. 1, for pre-weighting STBC output signals. The optimum weights are also used to multiply these received signals at the receiver. The scheduler arranges the weights as shown in the following Table.

Using the algorithm for implementing the optimum sub-channel weight scheme

| Scheduler | Antenna 1 | Antenna 2 |
|---|---|---|
| Time 1 | 14_{*1I} | W₁₂ |
| Time i + T | W_{2I} | W₂₂ |

according to the embodiment of the present invention, the update mean covariance matrix is, therefore, calculated using as many as the samples block length L of each channel coefficient, and then inputted to the Bayes decision rule for determining the optimum signal ranges, α_{;}* c R_{y}. This process is performed iteratively every L samples. Therefore, an optimum channel coefficient expressed as

Laiₜ₎,a_{; 2}^{r 1}>ai_{>}az*(L) (L) is thereby obtained.

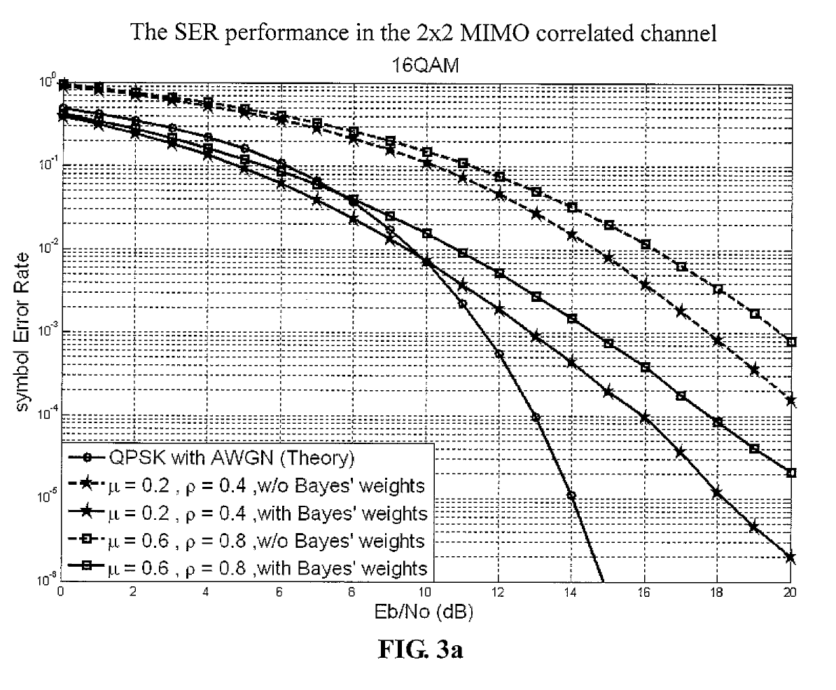

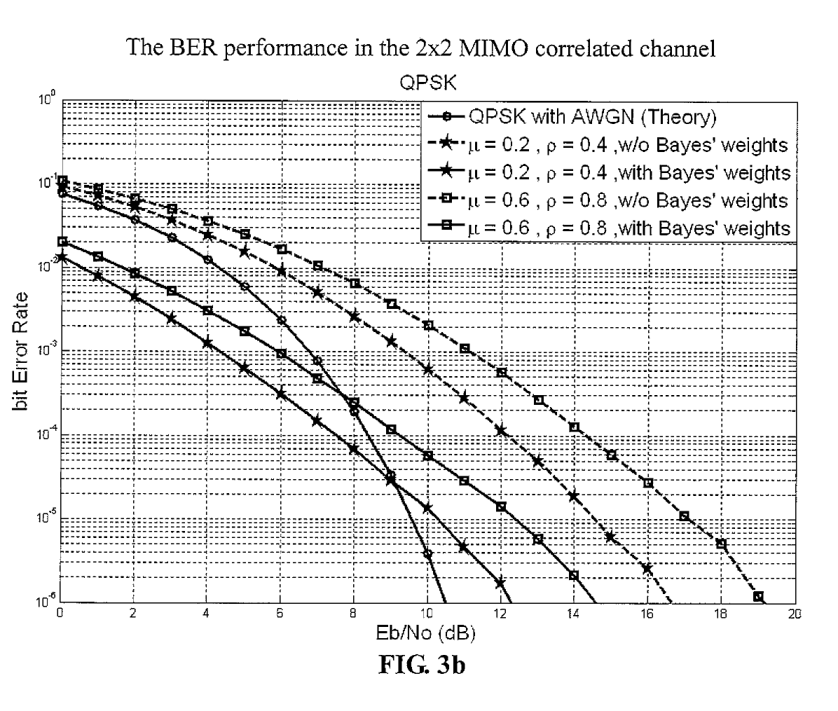

To further validate the accu^{r}acy of the FOW-based MIMO system, the BER analyses are presented in FIGS. 3a and 3b. FIGS. 3a and 3b show the simulation results obtained with QPSK and 16QAM, respectively, with perfect channel estimation. Consistent with the performance improvement K⁼2.55 (or 4.065 dB), the BER performance with proposed FOW technique is better than that with conventional Alamouti 2-branch TD scheme in the 2×2 ST MIMO system. Specifically, at the lower E_{b}/Nₒ, it is more robust in comparison to a single antenna with AWGN channel in both QPSK and 16QAM. At BER and SER (symbol-error-rate) level of 10⁻¹, there is about 4.2-4.4 dB performance gain for QPSK and 16QAM over the conventional Alamouti 2-branch TD under spatially-correlated fading channel, as shown in FIG. 3.

The present invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A FOW-based 2-by-2 multiple-input multiple-out (MIMO) wireless system, comprising:
a MIMO transmitter, further comprising a space-time block coder and a scheduler;
a 2-by-2 MIMO channel;
two FOW-based MIMO receivers;
an optimum weight vector module;
a coherent combining unit;
a maximum likelihood detector; and
an optimum decision algorithm module, for receiving output from said FOW-based MIMO receivers and computing an optimum weight vector, forward said optimum weight vector to said schedule of said MIMO transmitter and said optimum weight vector module;
where an optimum weight vector per data frame being adaptively generated, a plurality of channel coefficients being generated, corresponding channel coefficients being multiplied by said optimum weight vector, and a channel covariance being optimized.

2. The MIMO wireless system as claimed in claim 1, wherein said optimum channel covariance is updated adaptively per signal block length without requiring of the channel state information.

3. The MIMO wireless system as claimed in claim 1, wherein said optimum decision algorithm module comprises an extension of an average cost criterion under a Bayes decision rule for measuring an optimum signal range, and a threshold is determined by taking the maximum value of the measured signal range with respect to each said channel coefficient.

4. The MIMO wireless system as claimed in claim 1, wherein said optimum decision algorithm comprising a Bayes decision rule, a Maximum a posteriori decision rule, and a Minimum probability of error; and an equal a priori probability P(αᵢⱼ) is provided to each channel coefficient.

5. The MIMO wireless system receiver as claimed in claim 3, wherein said optimum decision algorithm is compatible for use in orthogonal frequency division multiplexing, spatial division multiple access, single-carrier based code-division multiple access, orthogonal space-time block code, Alamouti space-time encoder, and single-input multiple-output receiver antenna diversity wireless system environments

6. A scheme for optimizing the received signal-to-noise power ratio and data throughput for a MIMO wireless system, said MIMO wireless system having a scheduler in a MIMO transmitter, an optimum weight vector module and an optimum decision algorithm module, said optimum decision algorithm module receiving output from MIMO receivers and computing an optimum weight vector, forward said optimum weight vector to said schedule of said MIMO transmitter and said optimum weight vector module, said scheduler arranging optimum weight vector in accordance with space-time constellation signals, said scheme comprising the steps of:
measuring a plurality of channel coefficients;
calculating an equi-power covariance matrix of the transmitted output;
generating conditional probability density function with Rayleigh distribution;
determining a plurality of cost factors;
performing an average cost calculation using an average cost equation and said cost factors;
selecting a plurality of signal regions;
performing an M-likelihood optimum decision rule;
calculating an optimum channel coefficient;
determining a corresponding threshold value of the corresponding signal range;
obtaining an optimum weight vector; and
forwarding said optimum weight vector to an optimum weight vector module and feeding back to said scheduler via an uplink fast channel feedback.
